(19) United States
(12) Patent Application Publication
(10) Pub. No.: US 2009/0215006 A1
(43) Pub. Date: Aug. 27, 2009

(54) ROOT CANAL FILE

(76) Inventor: Stephan GABLER, Langebruck (DE)

Correspondence Address: HESLIN ROTHENBERG FARLEY & MESITI PC, 5 COLUMBIA CIRCLE, ALBANY, NY, 12203, US

(21) Appl. No.: 12/390,531

(22) Filed: Feb. 23, 2009

Related U.S. Application Data
(60) Provisional application No. 61/030,585, filed on Feb. 22, 2008.

(51) Int. Cl. A61C 5/02

(52) U.S. Cl. 433/102

(57) ABSTRACT

A root canal file with a rotating application for widening of the root canal of human or animal teeth to a stipulated diameter and cone by means of cutting edges running in a spiral along the root canal file has much higher flexibility, especially in areas with large diameter. The root canal file has at least two cutting edges; at least one of the cutting edges is recessed over its height, as well as along the root canal file in sections, forming a recess in alternation in several cross-sectional planes.

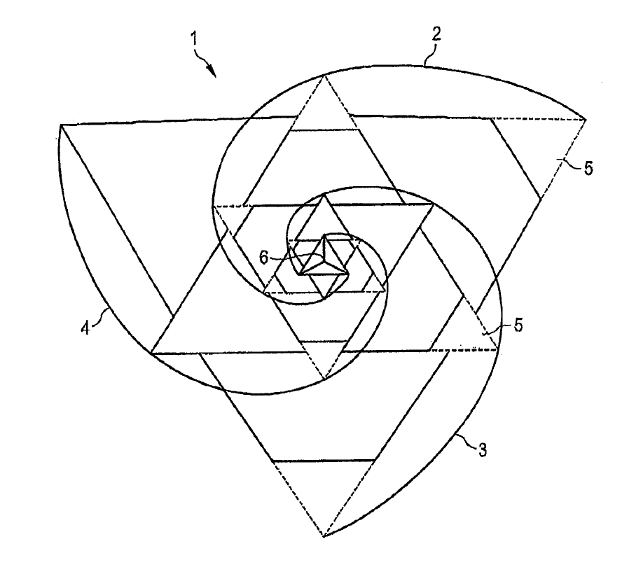

### BACKGROUND ART

The invention concerns a root canal file for rotating application to widen the root canal of human or animal teeth to a stipulated diameter and cone by means of cutting edges running in a spiral along the root canal file.

Root canal files for rotating widening of root canals are generally known. For this purpose, the root canal files have at least two or more cutting edges wound in a spiral, which extend over parts or the entire length of the file. The root canal files have a constant diameter or a diameter diminishing conically to a tip, which changes over the length of the file only slightly. The cutting edges, on the one hand, must remove substance and, on the other hand, keep or guide the root canal file centered by their cross-sectional distribution. In addition, the root canal files must be capable of being adapted to the natural trend of the root canal.

The cross-section of such files can be triangular, square or polygonal.

A dental root canal instrument is apparent from DE 197 23 695 C2. The root canal instrument described here has several sections over its length with different function. Initially, the instrument has a rigid shank to accommodate a handle, which is then continued in a more or less flexible working part with cutting edges wound in a spiral and ends in a guide section with an almost longitudinally running cutting edge. The diameter in the spiral part diminishes conically, whereas the guide section ends in a tip.

A shortcoming in such root canal files is that the necessary flexibility diminishes disproportionately with increasing diameter of the files. As a result, during further forming of root canals with instruments of large diameter, undesired straightenings of the trend of the root canal develop.

In order to improve the flexibility of root canal files, an attempt was made to reduce the core diameter of the files. An example of such a file is apparent from: Dentsply Maillefer, Maillefer Instruments CH-1338 Ballagaiues, Switzerland, 2006, “Brochure ProTaper Universal,” page 5.

Apart from the fact that reduction of the core diameter only has a slight effect on increasing the flexibility of the files, such an expedient is very costly.

### BRIEF SUMMARY OF THE INVENTION

The underlying task of the invention is to devise a highly flexible root canal file for rotating application that has much greater flexibility, especially in areas of large diameter.

The task underlying the invention is solved in a root canal file of the type just mentioned, in that in a root canal file with at least two cutting edges, one of the cutting edges is recessed over its height, as well as with the stipulated length, along the root canal file in sections in alternation with the other cutting edge in several cross-sectional planes.

In a first embodiment of the invention, two cutting edges of a cross-sectional plane in a root canal file with a triangular cross-section are provided with recesses that extend over a stipulated length of the corresponding cutting edge in the longitudinal direction of the root canal file, the recesses of adjacent cross-sectional planes being arranged offset by a stipulated angle.

The stipulated angle in two cutting edges is 180° and in three cutting edges 120° and correspondingly smaller with more cutting edges.

In continuing the invention, the remaining cutting edge of a cross-sectional plane, in conjunction with the adjacent remaining cutting edges of other cross-sectional planes, guide the root canal file centrally in the root canal.

The recesses can be produced simply by milling or grinding.

### BRIEF DESCRIPTION OF THE DRAWING FIGURE

The invention will be further explained below on a practical example. The corresponding drawing shows a schematic depiction, not to scale, of a root canal file 1 according to the invention, viewed from the tip, with three cutting edges 2, 3, 4 running in a spiral in several cross-sectional planes, one behind the other.

### DETAILED DESCRIPTION

Six cross-sectional planes are shown here. It is understood that a real root canal file must have a multitude of cross-sectional planes and might have a much smaller increase in diameter from cross-sectional plane to cross-sectional plane.

The desired increase in flexibility of the root canal file over its length is achieved according to the invention in that some of the cutting edges 2; 3; 4 are recessed in the longitudinal direction in sections and over their height. As is apparent from the drawing, in the case of three cutting edges 2, 3, 4, two cutting edges each 2; 3; 4 of a cross-sectional plane are provided with recesses 5, which extend over a stipulated length of the corresponding cutting edge in the longitudinal direction of the root canal file. A drop-like cross-section therefore develops from the triangular cross-section of the root canal file in the corresponding cross-sectional plane, which extends over a stipulated section of the root canal 1, in which the remaining corner forms the tip of the drop.

In the present case, two recesses 5 are provided in each plane, so that the third cutting edge of a cross-sectional plane is retained. This cutting edge 2; 3; 4 assumes the cutting function in the cross-sectional plane and the corresponding cutting edges of the next two adjacent cross-sectional planes together assume the necessary centering guide function. In each case, a significant reduction in weight is achieved on this account, which is expedient for the desired flexibility of the root canal file. The tip 6 of the root canal file 1 can remain unchanged and has three cutting edges. The tip 6 of the root canal file can also have a different shape and can be included, in particular, in the aforementioned configuration of the cutting edges, which entails the highest flexibility of the root canal file up to its tip 6, when necessary.

This stands in contrast to the prior art, where, in each cross-sectional plane with three cutting edges, the three cutting edges also assume the cutting and guide function.

The cutting edges of adjacent cross-sectional planes according to the invention are then recessed with an offset by a stipulated angle. The offset in two cutting edges is 180°, and in three cutting edges 120°. With more cutting edges, the angle is smaller accordingly.

The size of the recesses and the related weight reduction can be continued to the extent the stability of the file shape and the forces occurring during root canal widening permit.

A distinct increase in flexibility of root canal file 1 is therefore achieved with equivalent good centering in the root canal.

The basic idea is to achieve support in the root canal and root canal files with two or more spiral cutting edges, in that this occurs in distributed fashion over several cross-sectional planes, and in that a distinct weight reduction is simultaneously achieved in the cross-sectional planes by using only one cutting edge section in each cross-sectional plane, leaving out the additional cutting edges of the same cross-sectional plane.

It is understood that the structure of the root canal files according to the invention can be obtained by different expedients, on the one hand, already during manufacture of the blank or, on the other hand, subsequently by machining.

1. Root canal file for rotating application for widening of a root canal of human and animal teeth to a stipulated diameter and cone by means of cutting edges that run in a spiral along the root canal file, wherein the root canal file has at least two cutting edges, one of the cutting edges is recessed over the height and with a stipulated length along the root canal file in sections and in alternation with each other cutting edge in several cross-sectional planes.

2. Root canal file according to claim 1, wherein the root canal file has a triangular cross-section, two cutting edges of a cross-sectional plane are provided with recesses, which extend over a stipulated length of the corresponding cutting edge in a longitudinal direction of the root canal file, the recesses of adjacent cross-sectional planes being arranged offset by a stipulated angle.

3. Root canal file according to claim 2, wherein the stipulated angle in two cutting edges is 180° and in three cutting edges 120°.

4. Root canal file according to claim 1, wherein a remaining cutting edge of a cross-sectional plane guides and centers the root canal file with the adjacent remaining cutting edges.

5. Root canal file according to claim 2, wherein the recesses are formed by milling or grinding.
